(19) United States
(12) Patent Application Publication
(10) Pub. No.: US 2015/0169733 A1
(43) Pub. Date: Jun. 18, 2015

(54) SYSTEMS AND METHODS FOR LINKING A DATABASE OF OBJECTIVE METRICS TO A PERFORMANCE SUMMARY

(71) Applicants: Nima Motamedi, Toronto (CA); Shaahin Mehdinezhad Rushan, Richmond Hill (CA); James Fai-Kuen Tam, Toronto (CA); Alireza Bakhtiari Koohsorkhi, Toronto (CA); Charmaine Abalajon, Toronto (CA); Gregory Lapouchnian, Toronto (CA); Shozub Qureshi, Bellevue, WA (US); Tam Duc Tran, Toronto (CA); Ashwini Govindaraman, Hayward, CA (US)

(72) Inventors: Nima Motamedi, Toronto (CA); Shaahin Mehdinezhad Rushan, Richmond Hill (CA); James Fai-Kuen Tam, Toronto (CA); Alireza Bakhtiari Koohsorkhi, Toronto (CA); Charmaine Abalajon, Toronto (CA); Gregory Lapouchnian, Toronto (CA); Shozub Qureshi, Bellevue, WA (US); Tam Duc Tran, Toronto (CA); Ashwini Govindaraman, Hayward, CA (US)

(21) Appl. No.: 14/541,394

(22) Filed: Nov. 14, 2014

Related U.S. Application Data
(60) Provisional application No. 61/904,704, filed on Nov. 15, 2013.
(60) Provisional application No. 61/904,723, filed on Nov. 15, 2013.
(60) Provisional application No. 61/904,733, filed on Nov. 15, 2013.

(51) Int. Cl. G06F 17/30; G06F 3/0482; G06F 3/0481

(52) U.S. Cl. CPC G06F 17/30601; G06F 17/30554; G06F 3/04817; G06F 3/0482

(57) ABSTRACT

Methods and systems are provided for appending data objects to answers while conducting performance reviews. A user interface includes an interactive module for presenting a question and receiving an associated answer; a selection field including virtual buttons corresponding to a plurality of respective performance metrics; a timeline feed configured to present an immersive view of at least one of the plurality of respective performance metrics; and a citation icon for use in appending at least one data element to the answer.

### CROSS-REFERENCE TO RELATED APPLICATIONS

This application claims the benefit of the following U.S. provisional patent applications: i) Ser. No. 61/904,704 filed Nov. 15, 2013; ii) Ser. No. 61/904,723 filed Nov. 15, 2013; and iii) Ser. No. 61/904,733 filed Nov. 15, 2013. The entire contents of the foregoing applications are incorporated herein by this reference.

### TECHNICAL FIELD

Embodiments of the subject matter described herein relate generally to computer systems and applications for conducting performance reviews, and more particularly to techniques for supplementing answers to questions with objective evidence.

### BACKGROUND

Incentivizing employees is a key metric in the success of any business. Thorough and unbiased performance summaries promote employee satisfaction. Performance Reviews, a graphical user interface (GUI) tool available at www.successfactors.com, measures employee performance, facilitates legal and regulatory compliance, creates a review audit trail, identifies top performers, and deploys using configurable review routing and email integration for reminders and deadlines.

7Geese™, available at www.7geese.com, provides a social performance tool for continuous feedback, coaching, recognition, and goal tracking without relying on traditional written performance reviews.

In addition, collaborative technologies have changed the way groups of related users (e.g., sales teams) share information about sales opportunities and support other team members. Presently known enterprise social network platforms such as Chatter™, released in June 2010 by Salesforce™ and available at www.salesforce.com, provide users with a feed-based stream of tracked objects such as sales goals, badges, and coaching.

Traditional employee evaluations, also referred to as performance summaries, are often boring, bland, and merely text based. Answers to questions about a person's performance over the previous employment cycle (e.g., one year) often rely on memory and subjective feelings instead of objective data and proof. As a result, performance summaries are frequently inaccurate and/or biased, which tends to degrade employee morale. Accordingly, it is desirable to provide techniques which address these shortcomings.

At the same time, software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation within tenant organizations without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

Presently known tools for evaluating employee performance are disadvantageous in that they do not adequately incorporate objective performance metrics. Accordingly, systems and methods are needed which more effectively exploit existing databases of tracked objects relevant to employee performance.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures, and:

FIG. 1 is a schematic block diagram of a multi-tenant computing environment in accordance with an embodiment;

FIG. 2 is an exemplary layout of a user interface for preparing a performance summary in accordance with an embodiment;

FIGS. 3-18 are screen shots of exemplary GUI pages illustrating various aspects of the process of integrating objective supporting data from a linked database into a performance summary in accordance with various embodiments; and

FIG. 19 is a flow chart illustrating an exemplary method of providing a reviewer with access to data objects in the context of completing an employee evaluation in accordance with an embodiment.

### DETAILED DESCRIPTION

Embodiments of the subject matter described herein generally relate to systems and methods for providing objective evidence to support answers to questions in the context of an employee performance review. As explained in greater detail below, the present disclosure describes tools for providing ready access to various categories of information for use by a reviewer in supplementing a Q&A performance summary format.

In one embodiment, a user interface for preparing an employee performance evaluation creates a link to a timeline view of various metrics associated with the employee's performance during the period covered by the evaluation. For example, throughout the work year, as facts and/or activities are generated, an employee creates a link in the employee's own version of a performance summary to various tracked objects representative of the employee's recent work in a timeline view. Additionally, the employee may browse through activity generated and available to reviewers and highlight certain items with a “star” or other tag.

The user interface displays the Q&A portion of the performance summary, augmented by a timeline of specific instances of performance metrics such as goals, feedback, coaching, thanks, and previous performance summaries retrieved from a linked database. For example, the employee may display the timeline view of recent work to a reviewer to assist the reviewer in filling out the reviewer's performance summary. In one embodiment, the timeline view of work related activity may show, along a horizontal or vertical axis, summarized tiles of activity.

The user interface may be configured to allow the user to select a “recent work” link from within the performance evaluation template, to thereby reveal various categories of performance metrics. Such metrics may include text from peer summaries, graphics or images (such as dashboards, reports), feedback, thanks, and badges received from other users, goals, and/or actions taken. Upon clicking on a tile or card in the timeline view, a modal view or an immersive view of the activity may be provided for display to show a more detailed level of activity.

In another embodiment, a user interface provides a link within a performance summary to a hybrid timeline and object type view of various metrics associated with the employee's performance during the period covered by the evaluation. The hybrid timeline and object type view of these facts combines a timeline view, such as by month, and an object or category type view, such as by thanks, feedback, goals, and actions.

In a further embodiment, a user interface provides a link within a performance summary to a system-generated highlight of user work associated with the employee's performance during the period covered by the evaluation. For example, below one question, a text box may include a toggle button for the reviewer to view “Recent Work.” Upon selecting the recent work toggle button, the reviewer is provided with various views of the employee's performance, which may include the employee's citation of the employee's own work, activity received about the employee in various views, such as by timeline view or hybrid timeline and object type view, and system-generated highlights/widgets for the employee being reviewed. Throughout the work year, as important milestones, moments, and/or achievements are reached, the system may automatically populate a linked database with pieces of evidence or proof of the employee's recent work as a portfolio of work related highlights. The system-generated highlights/widgets may include graphs, dashboards, and reports based on actual data, such as leads created, closed opportunities, pipeline generation, and opportunities lost.

In another embodiment, a link may be included proximate the Q&A portion of the performance summary to “continue your answer” using the citation feature. The reviewer may navigate the presented data, and tag or annotate the data in such a way to effectively answer the question in addition to or without having to manually generate responsive text. By way of non-limiting example, if a question asks “How well did the employee accomplish his goals?” the system may automatically present the reviewer with the employee's goals, along with the methods and metrics of the employee's achievement of those goals, and also may be presented with the employee's own user-created highlights of activity. The reviewer may simply identify that the employee completed all or some portion of the goal related methods and metrics, providing citations of the raw data to answer the question.

In a further embodiment, the worksheet interface may also display text from peer summaries. The worksheet interface may display a timeline view that includes text from peer summaries in addition to the previously discussed metrics.

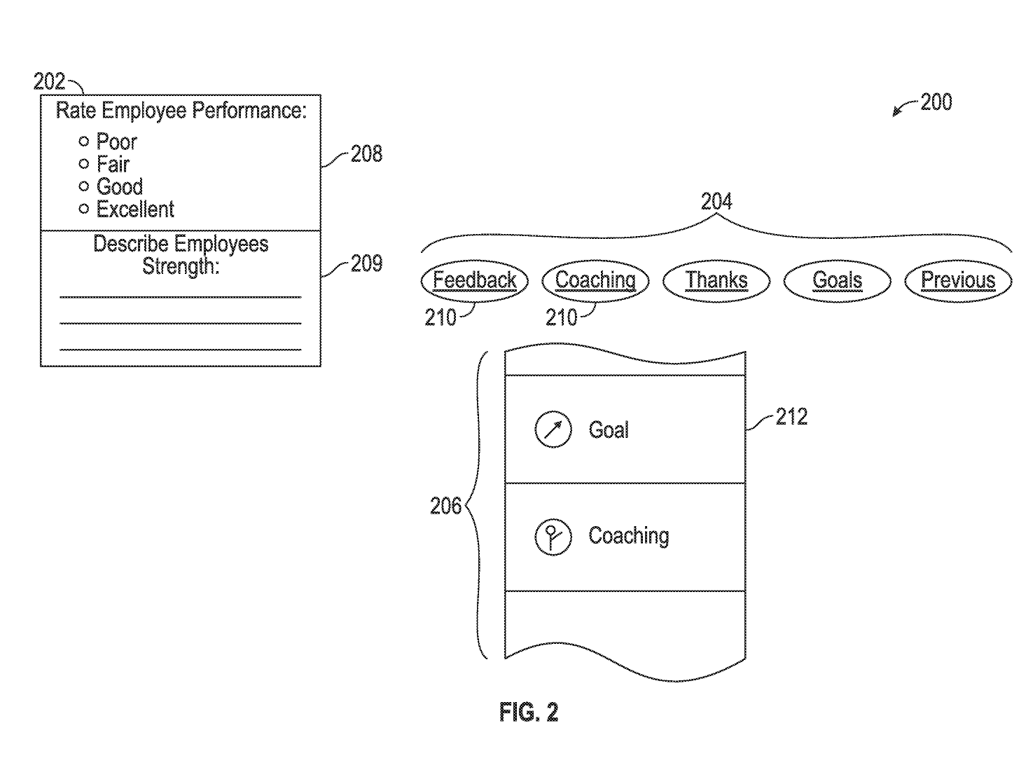

Various implementations of the foregoing embodiments are described in greater detail below in conjunction with FIGS. 2-19.

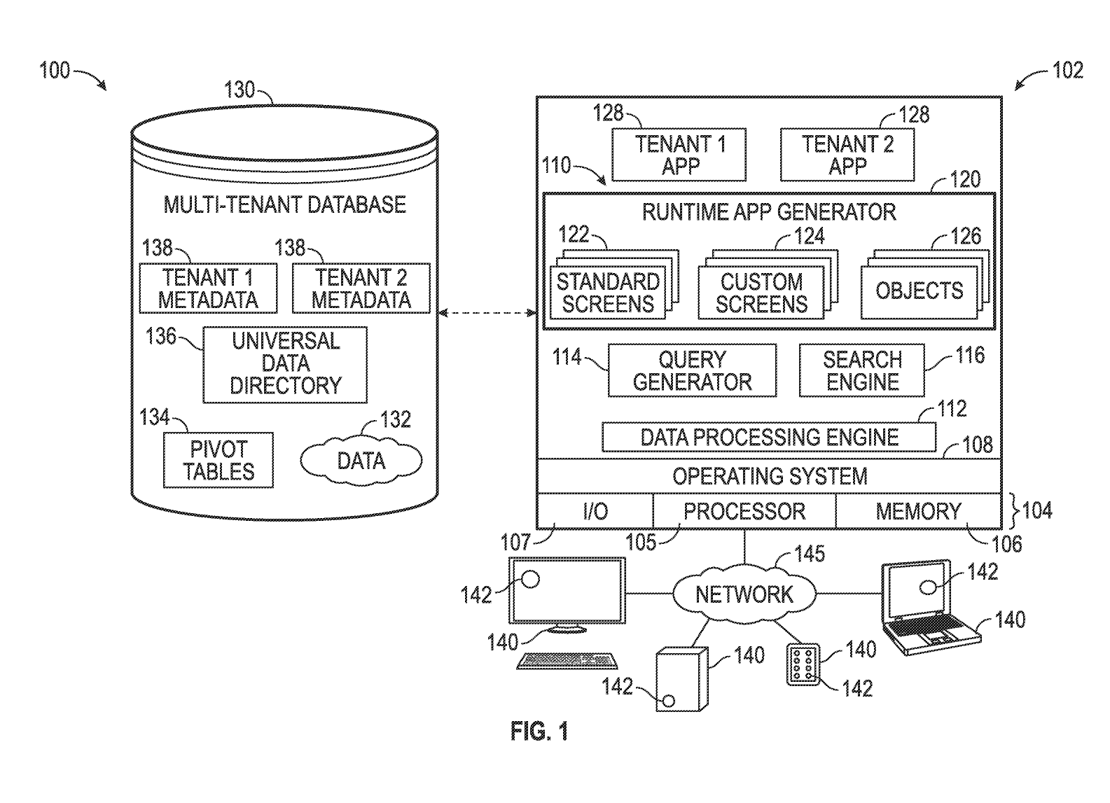

Turning now to FIG. 1, an exemplary cloud based performance summary solution may be implemented in the context of a multi-tenant system 100 including a server 102 that supports applications 128 based upon data 132 from a database 130 that may be shared between multiple tenants, organizations, or enterprises, referred to herein as a multi-tenant database. Data and services generated by the various applications 128 are provided via a network 145 to any number of client devices 140, such as desk tops, laptops, tablets, smartphones, Google Glass™, and any other computing device implemented in an automobile, aircraft, television, or other business or consumer electronic device or system, including web clients.

Each application 128 is suitably generated at run-time (or on-demand) using a common application platform 110 that securely provides access to the data 132 in the database 130 for each of the various tenant organizations subscribing to the service cloud 100. In accordance with one non-limiting example, the service cloud 100 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 130. In this regard, each tenant includes one or more users and/or groups associated with, authorized by, or otherwise belonging to that respective tenant. Stated another way, each respective user within the multi-tenant system 100 is associated with, assigned to, or otherwise belongs to a particular one of the plurality of enterprises supported by the system 100.

Each enterprise tenant may represent a company, corporate department, business or legal organization, and/or any other entities that maintain data for particular sets of users (such as their respective employees or customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other organizations.

The multi-tenant database 130 may be a repository or other data storage system capable of storing and managing the data 132 associated with any number of tenant organizations. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

In an exemplary embodiment, the database 130 includes a database management system or other equivalent software capable of determining an optimal query plan for retrieving and providing a particular subset of the data 132 to an instance of application (or virtual application) 128 in response to a query initiated or otherwise provided by an application 128, as described in greater detail below. The multi-tenant database 130 may alternatively be referred to herein as an on-demand database, in that the database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. However, if a user chooses to manually upload an updated file (through either the web based user interface or through an API), it will also be shared automatically with all of the users/devices that are designated for sharing.

As noted above, the virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128. In various embodiments, application 128 embodies the functionality of an interactive performance review template linked to a database of performance metrics, as described below in connection with FIGS. 2-19.

Referring now to FIG. 2, an exemplary schematic layout 200 of a user interface for preparing a performance summary includes a question and answer (Q&A) portion 202, an object selection field 204, and a timeline display region 206. More particularly, Q&A portion 202 may include multiple choice type question portion 208 which prompts the reviewer to select from predefined answers, and an open ended question portion 209 which prompt the reviewer for a written answer. In either case, the reviewer may supplant a response with supporting data retrieved from a linked database. In various embodiments, the object selection field 204 comprises a plurality of user selectable categories of performance metrics 210 including, for example, feedback, coaching, thanks, goals, and previous summaries, with each category having an associated virtual button. By selecting a particular category, the underlying data for that category may be displayed in a feed 212 within the display region 206. Alternatively, a hybrid type feed may be configured to display multiple categories, interleaved temporally.

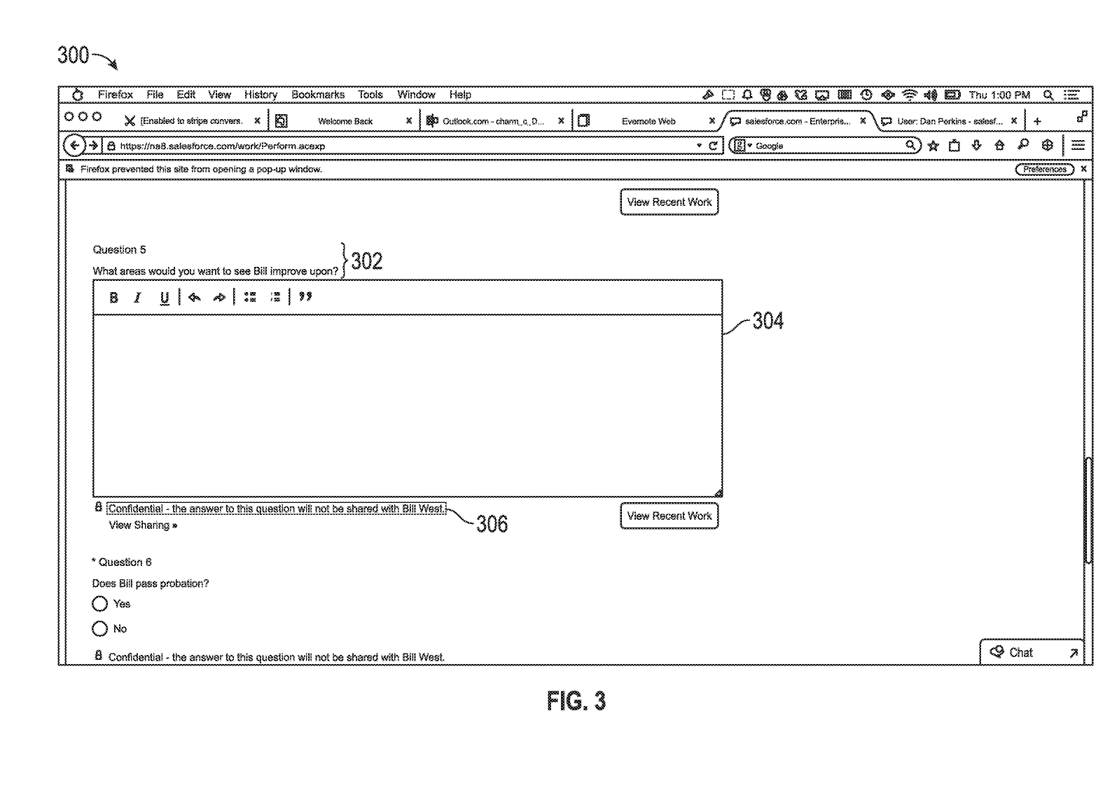

FIGS. 3-18 are screen shots of exemplary GUI pages illustrating various aspects of the process of integrating objective supporting data from a linked database into a performance summary in accordance with various embodiments.

More particularly, FIG. 3 is a screen shot 300 of a question 302 and an answer space 304 (generally analogous to portion 209 in FIG. 2) for providing a manually written answer regarding a work related performance aspect of an employee (or other party) under review. The illustrated embodiment also includes a confidentiality indicator 306, which informs the reviewer that the answer will not be shared with the reviewee.

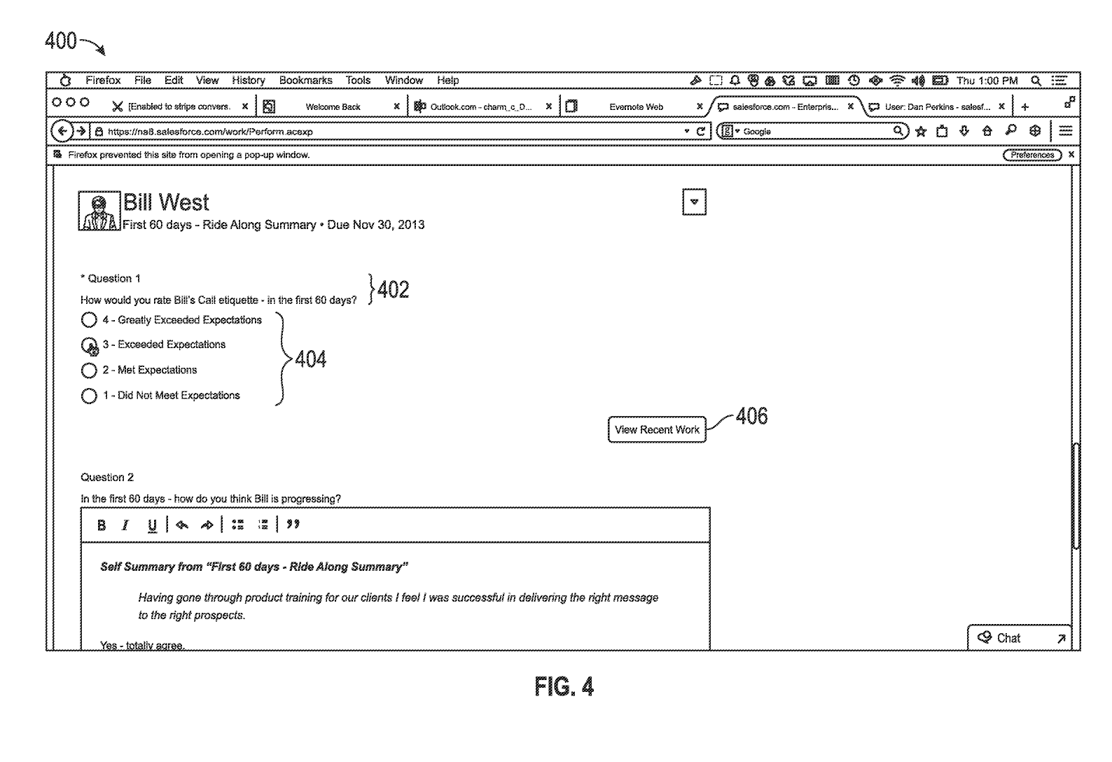

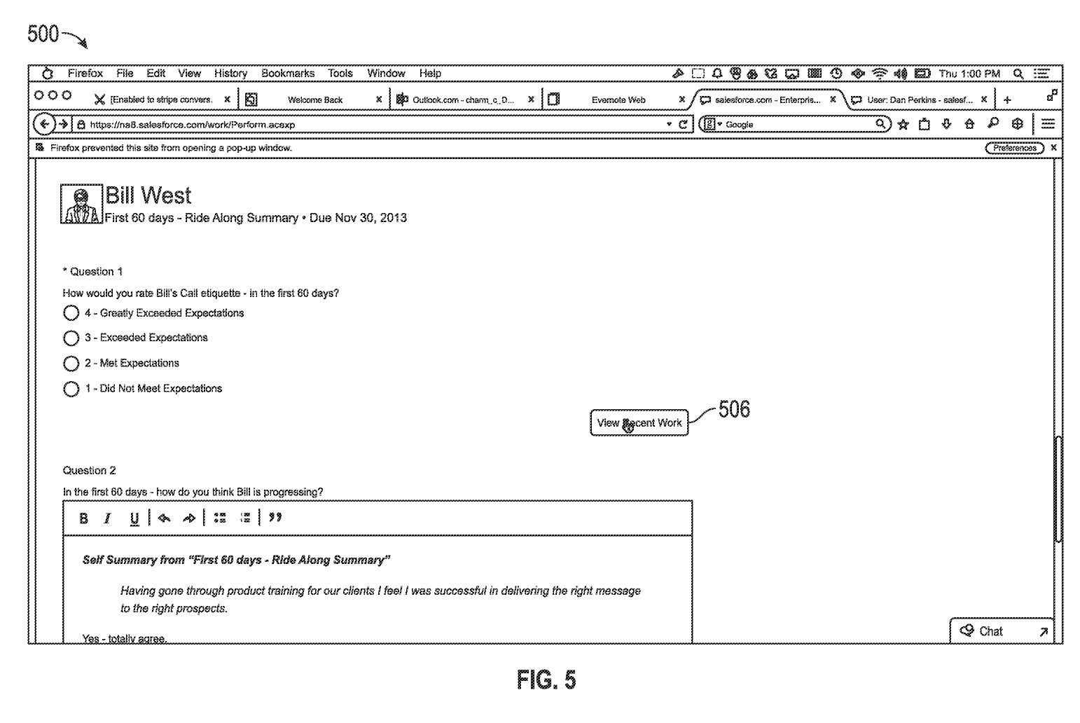

FIG. 4 is a screen shot 400 showing a multiple choice type question 402 and a plurality of predefined answers 404 (generally analogous to portion 208 in FIG. 2). In connection with answering either type (multiple choice or open ended) of question, the reviewer may select a “View Recent Work” virtual button 406 to display categories of tracked objects relating to the employee's past performance. FIG. 5 is a screen shot 500 generally analogous to FIG. 400, illustrating the user selecting the view recent work link 506.

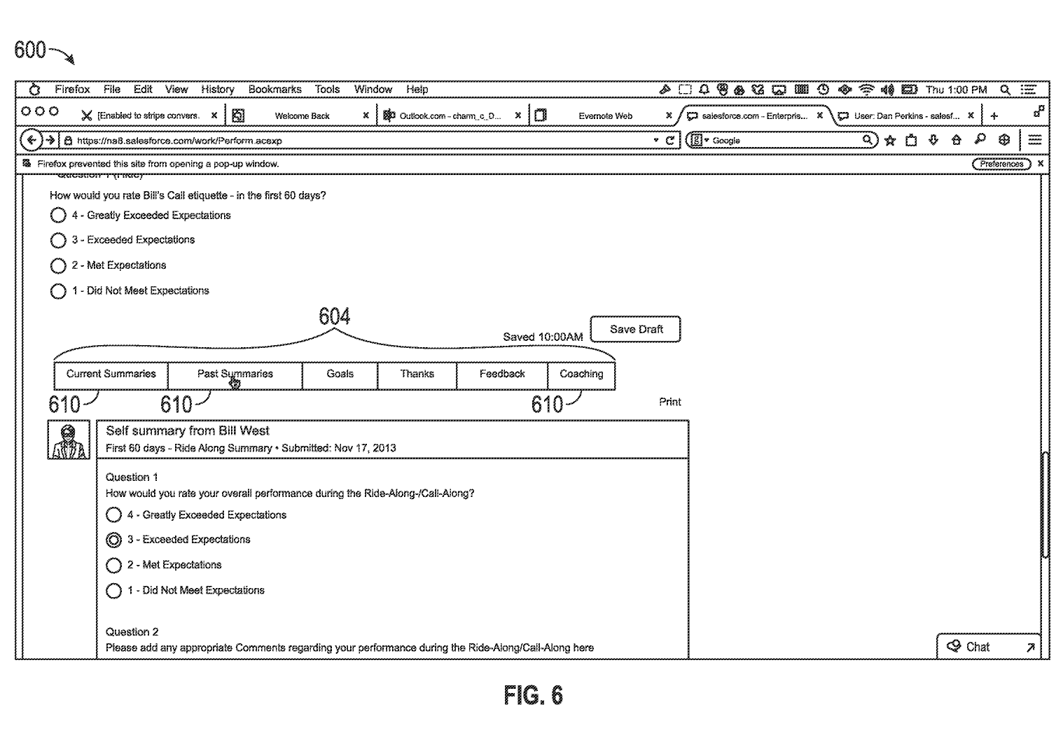

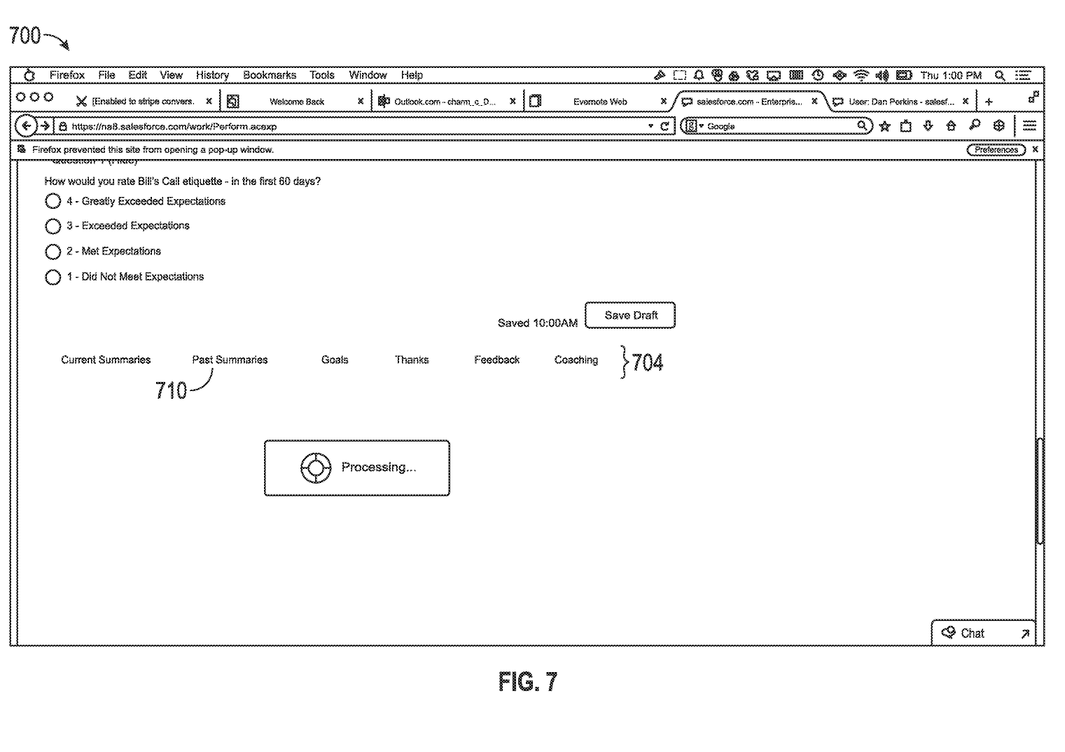

FIG. 6 is a screen shot 600 illustrating an object selection field 604 (generally analogous to the object selection field 204 of FIG. 2). In particular, the object selection field 604 includes one or more categories 610 of performance metrics such as feedback, coaching, thanks, goals, current summaries, and previous summaries, with each category having an associated virtual button. FIG. 7 is a screen shot 700 illustrating the user selecting a particular category 710 (e.g., past summaries) from an object selection field 704.

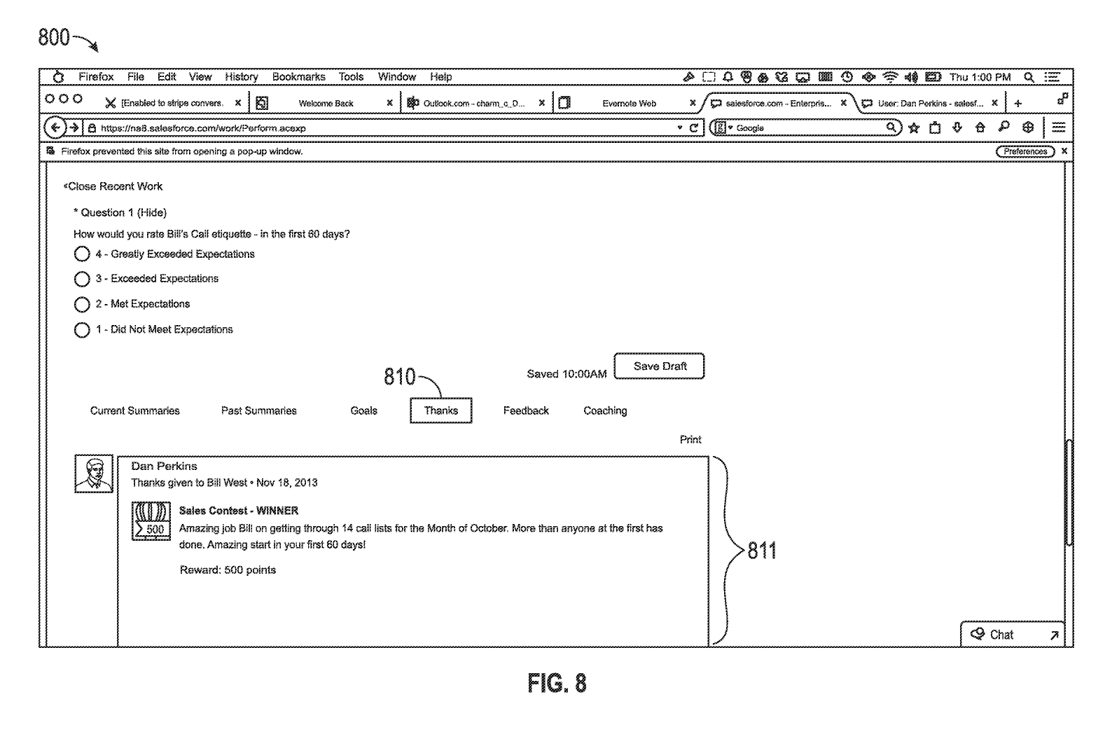

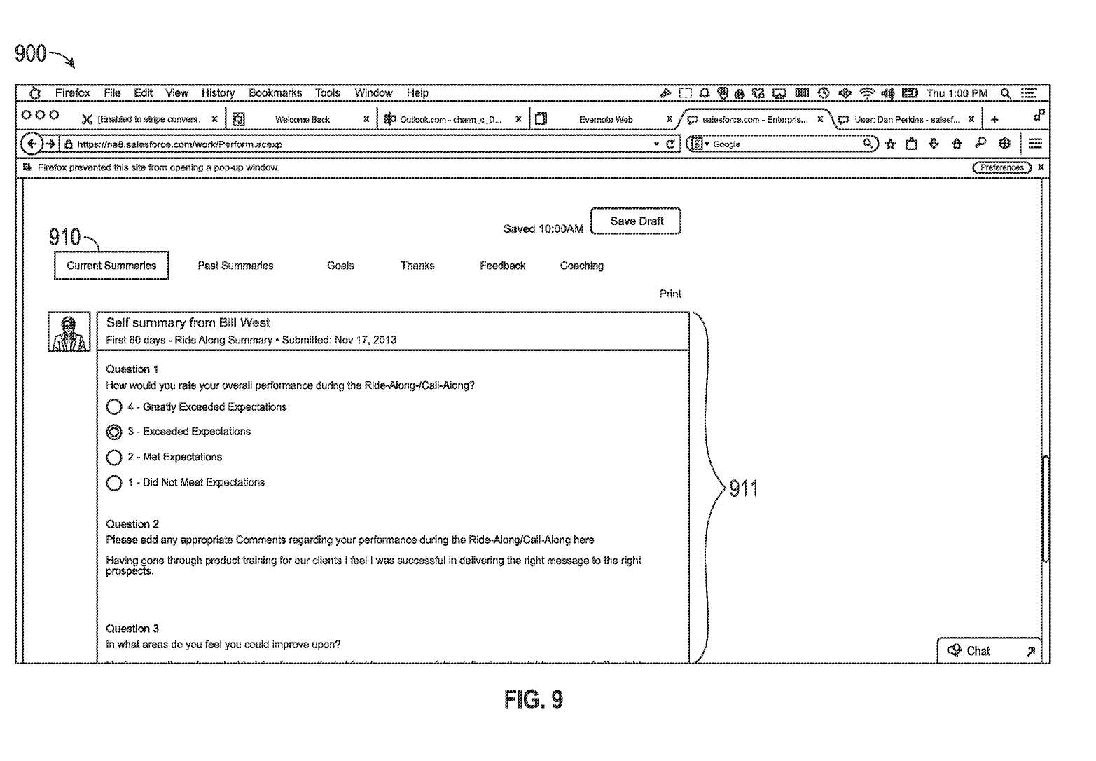

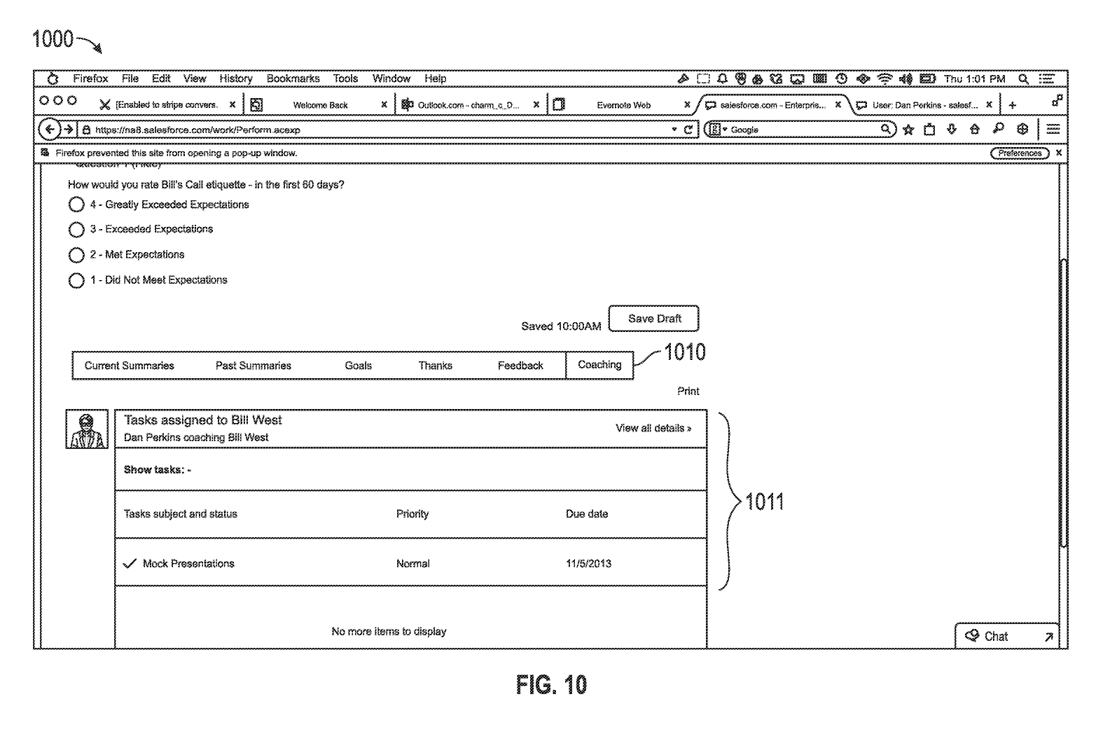

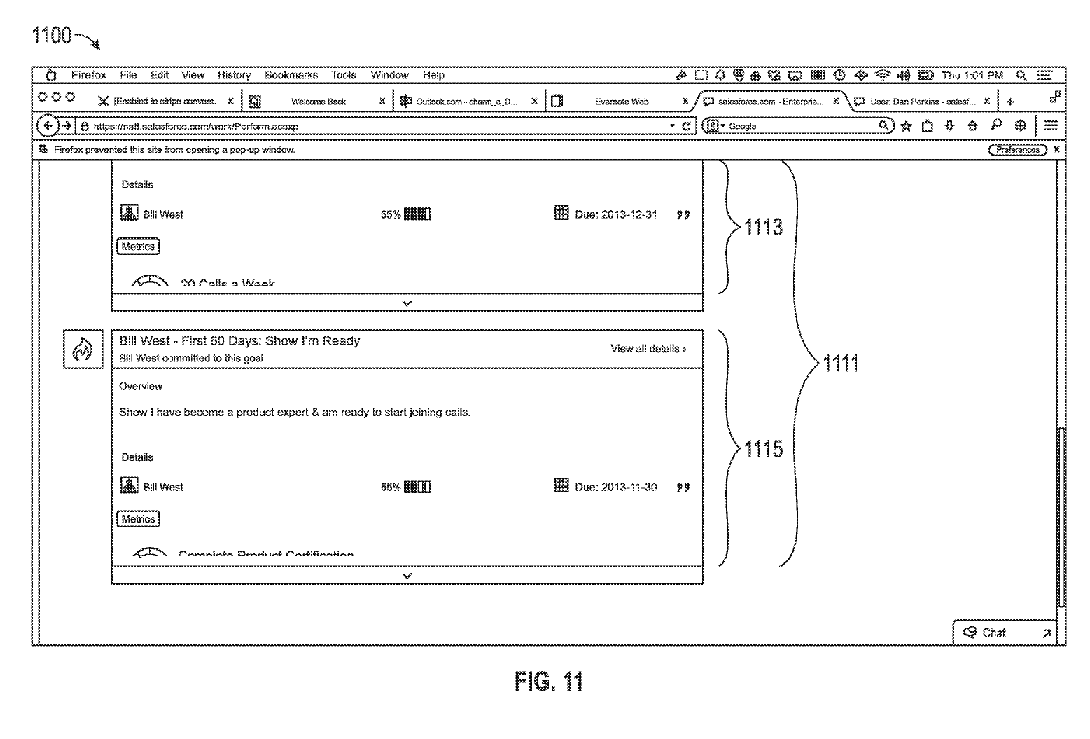

In response to the selection of a particular category of performance metrics, the system displays immersive detail associated with the selected category. FIG. 8 is a screen shot 800 illustrating details 811 of a selected category 810 (“thanks” in the illustrated example). FIG. 9 is a screen shot 900 illustrating details 911 of a selected category 910 (“current summaries” in the illustrated example). FIG. 10 is a screen shot 1000 illustrating details 1011 of a selected category 1010 (“coaching” in the illustrated example). FIG. 11 is a screen shot 1100 of the immersive detail 100 associated with the goals category, including a first goal 1113 shown as 55% completed, and a second goal 1115 shown as 27% completed at the time of the review.

As described in greater detail below, after reviewing the immersive detail for one or more categories, the user can cite one or more objects from the detail for inclusion into the performance summary to thereby provide objective data to support an answer.

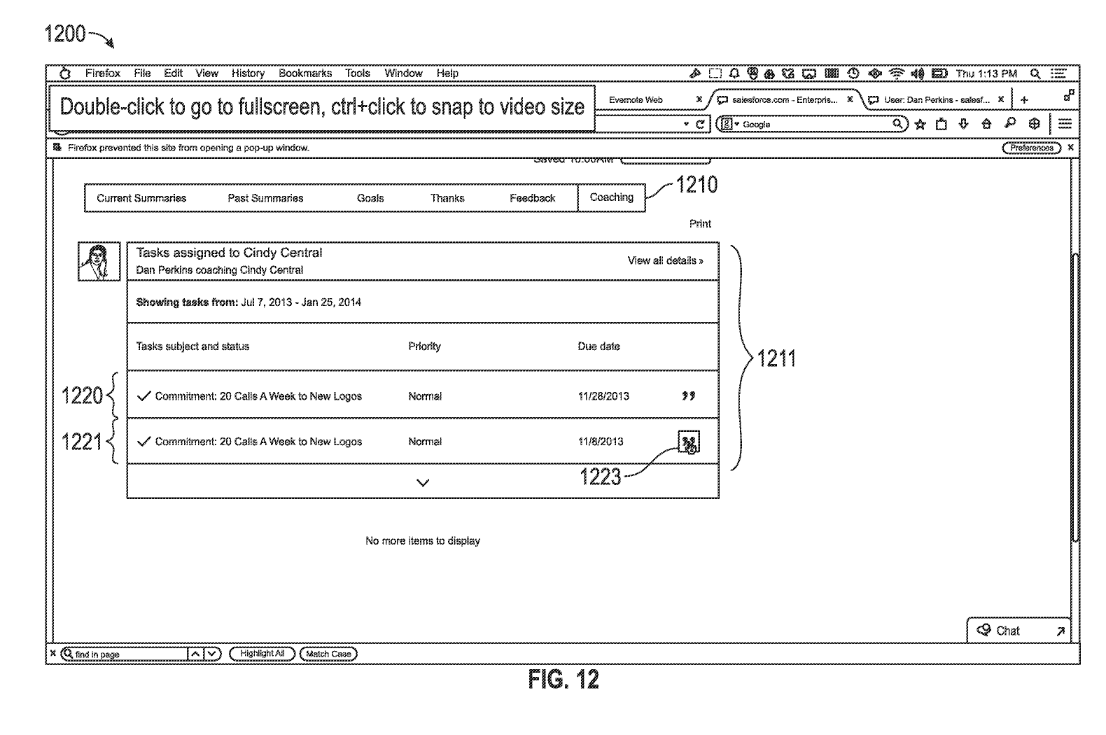

More particularly, FIG. 12 is a screen shot 1200 illustrating a technique for adding a performance metric in support of an answer. In particular, screen shot 1200 depicts detail 1211 for a coaching category 1210, where the detail 1211 includes a first entry 1220 and a second entry 1221. By clicking on a citation icon 1223 (e.g., stylized quotation marks) associated with the second coaching entry 1221, the user indicates a desire to add the coaching entry data object 1221 to the reviewer's answer to the then current question.

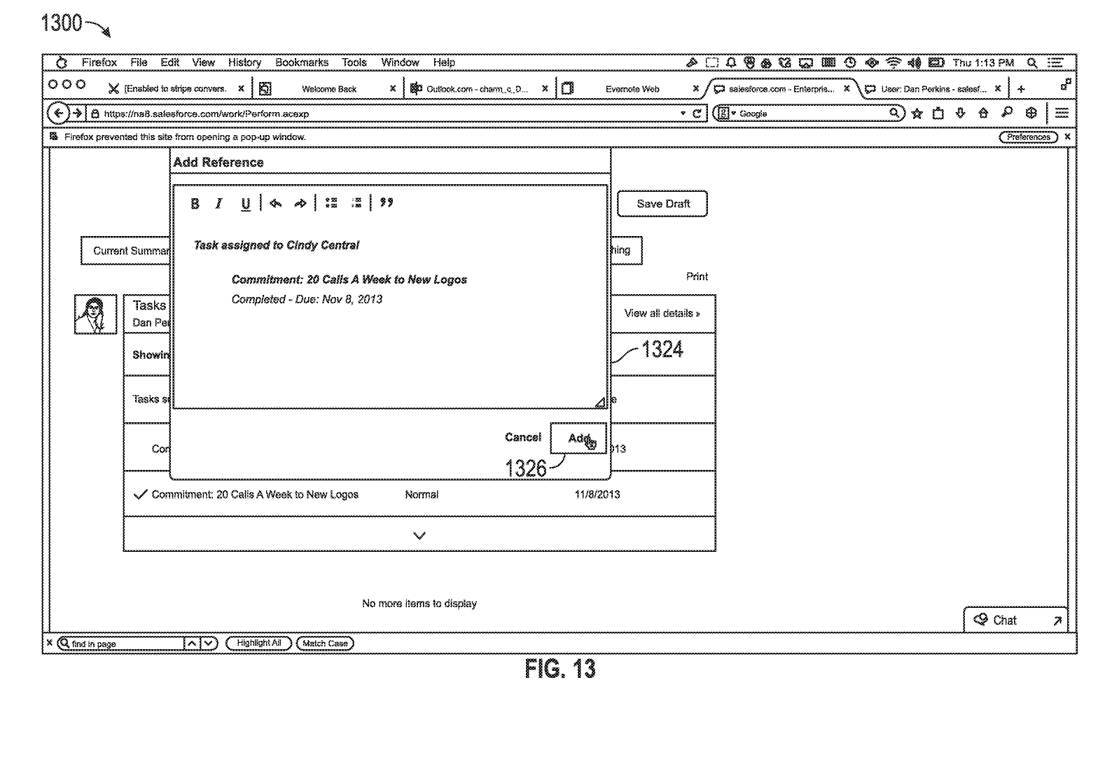

Referring now to FIG. 13, a screen shot 1300 displays an “add reference” window 1324 in response to selecting the citation icon 1223, whereupon the user may either cancel the proposed citation, or click the “add” icon 1326 to confirm the addition of the object to the answer.

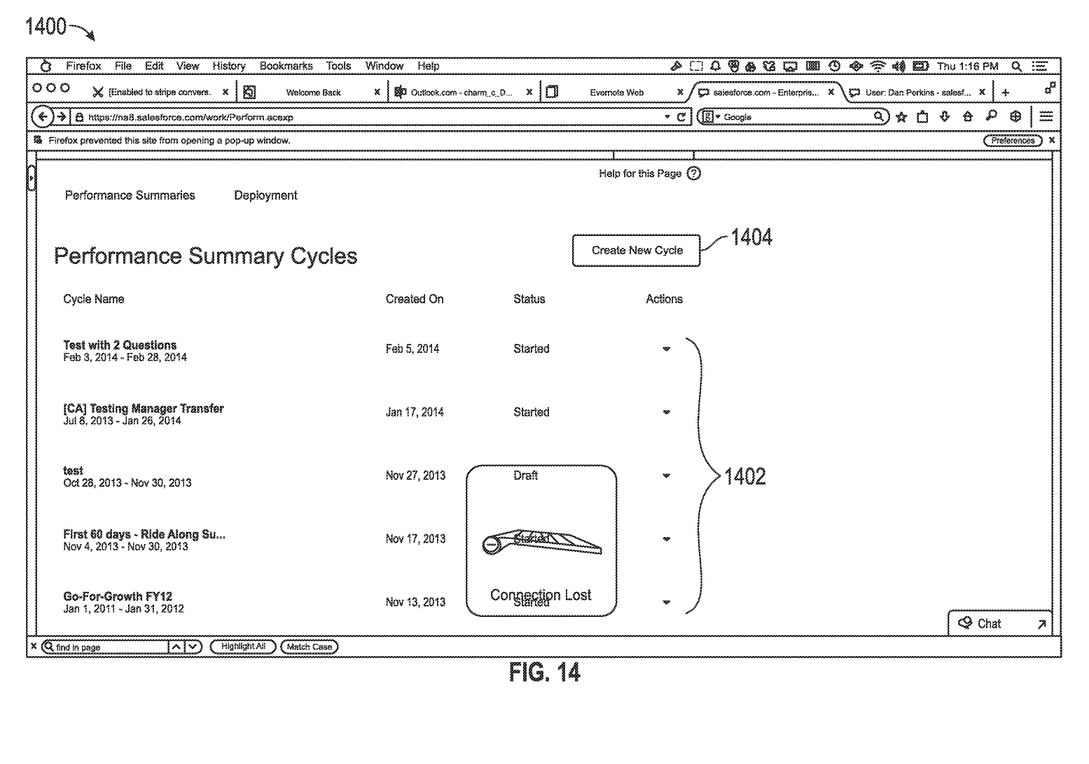

With reference to FIGS. 14-18, the manner in which performance summaries may be created and deployed in accordance with various embodiments will now be described.

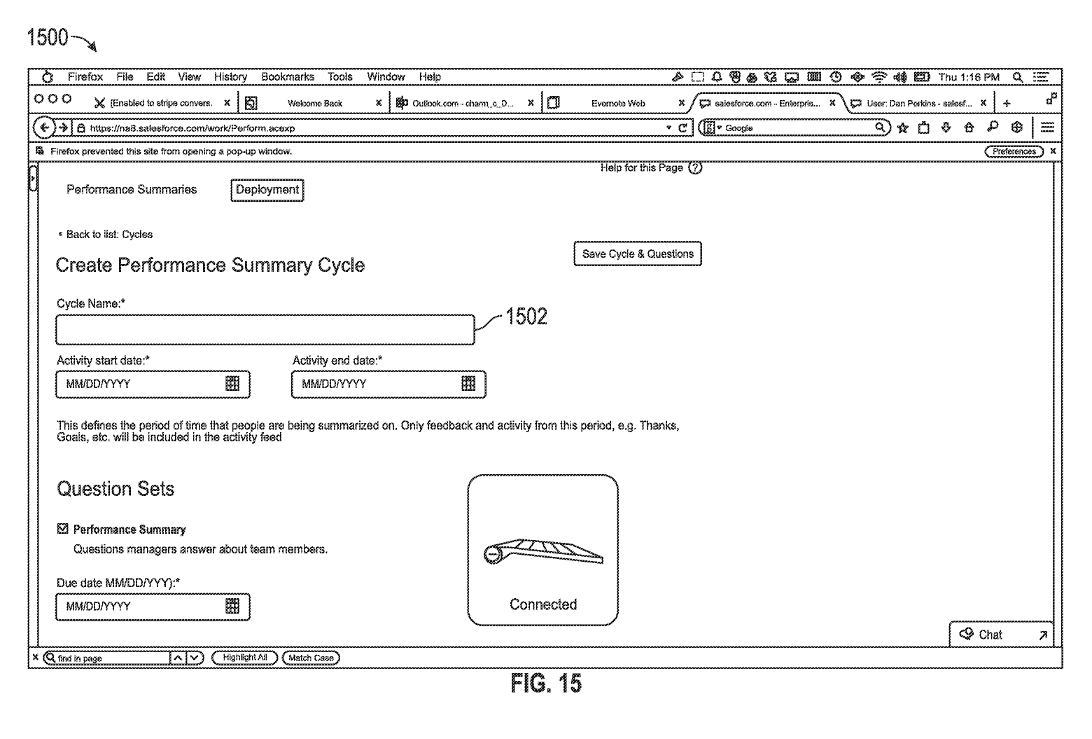

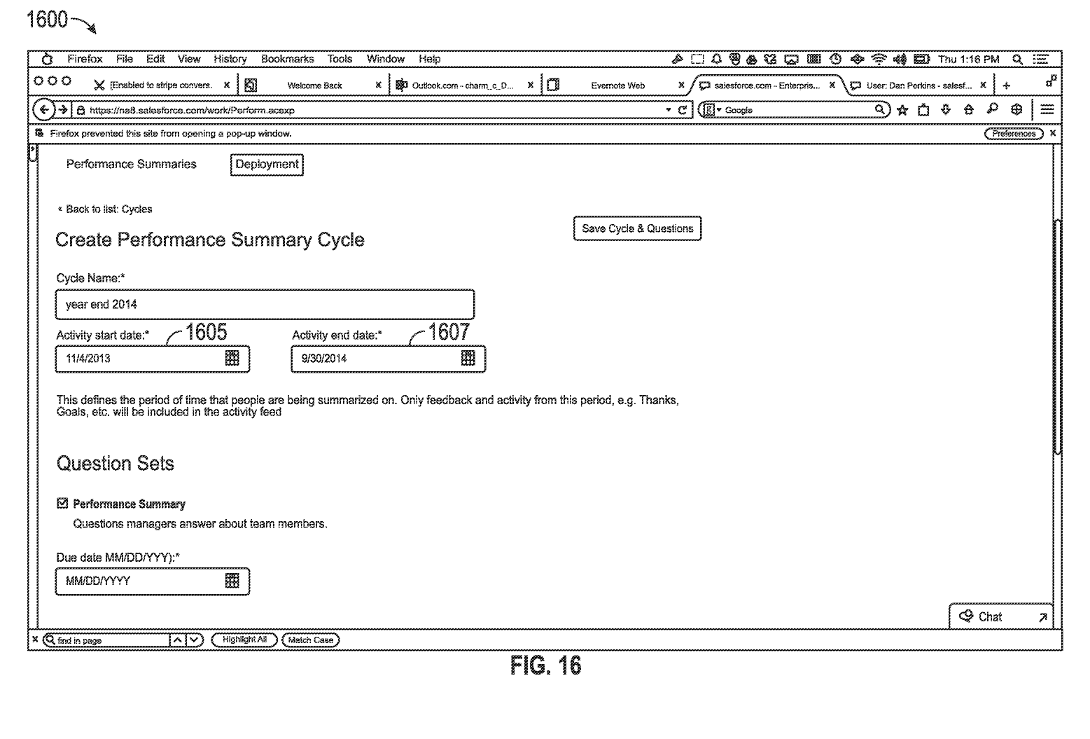

FIG. 14 is a screen shot 1400 of an administrator level GUI for use by a human resource (HR) manager to create a performance summary, including a list 1402 of existing performance summaries, and new cycle link 1404 for creating a new performance summary. Upon user selection of the link 1404, a screen shot 1500 (FIG. 15) prompts the user to enter the name of the new cycle in a name field 1502. FIG. 16 is a screen shot 1600 including a beginning date field 1605 and an end date field 1607. By completing these date fields, the HR administrator (or other user) defines the relevant time period for which the employee is being reviewed, and at the same time determines the temporal boundaries for the tracked performance objects to be presented to reviewers to assist them in completing the summary.

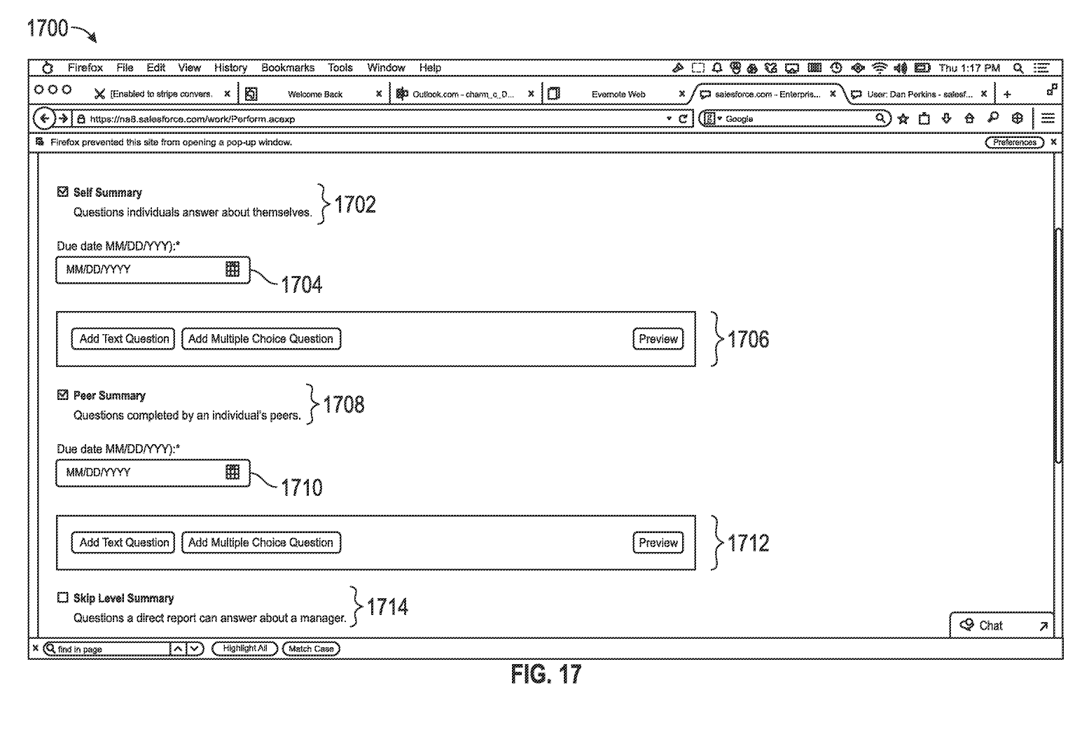

FIG. 17 is a screen shot 1700 for determining which parties are to provide a performance summary for the performance cycle under construction. For example a first party field 1702 may define a self summary, indicating that the employee is expected to complete his or her own evaluation. A first due date field 1704 defines when the self summary is due, and a first question field 1706 allows the HR administrator to preview, add, or delete text questions and/or multiple choice questions. The screen shot 1700 further includes a second party field 1708 for defining additional parties required or requested to evaluate the employee. In the illustrated embodiment, the second party field is a peer summary, indicating that the summary will be sent to one or more of the employee's peers for completion. A second due date field 1710 defines when the peer summaries are due, and a second question field 1704 may be used to define the peer questions. One or more additional party fields 1714 (and corresponding due date and question configuration fields) may also be provided to gather performance input from supervisors, subordinates, direct reports, cross reports, and/or any other person or entity from whom input is desired.

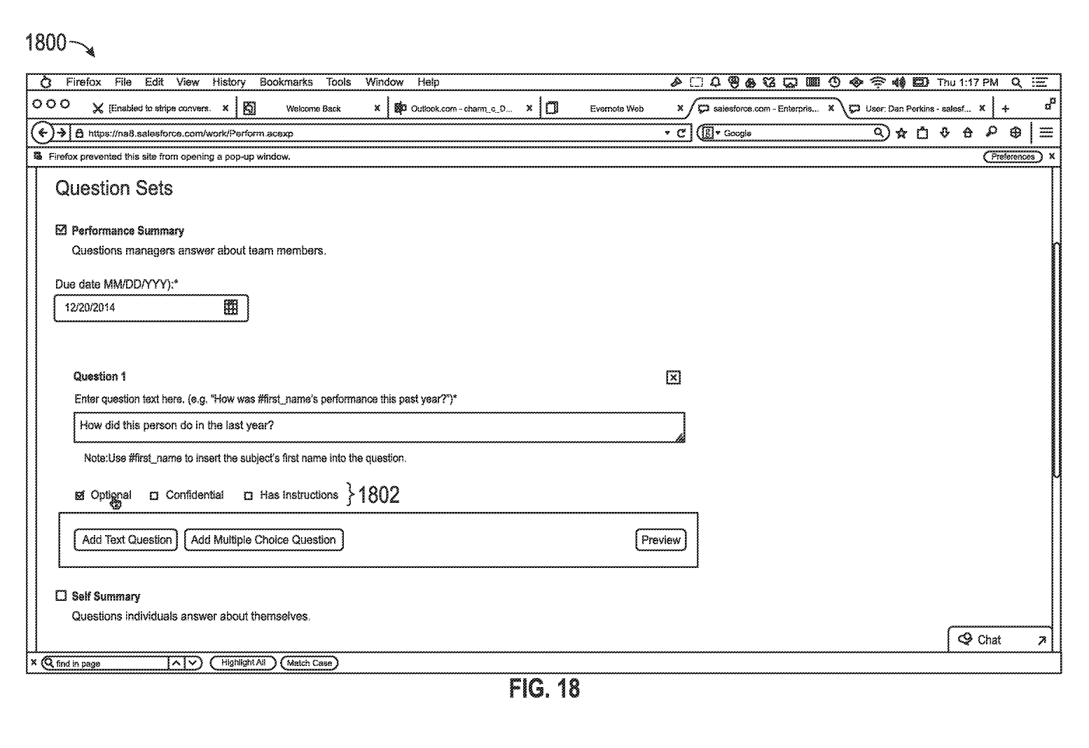

FIG. 18 is a screen shot 1800 including a customization field 1802 which allows each question to be designated as optional, confidential, or otherwise configured (e.g., to include further instructions).

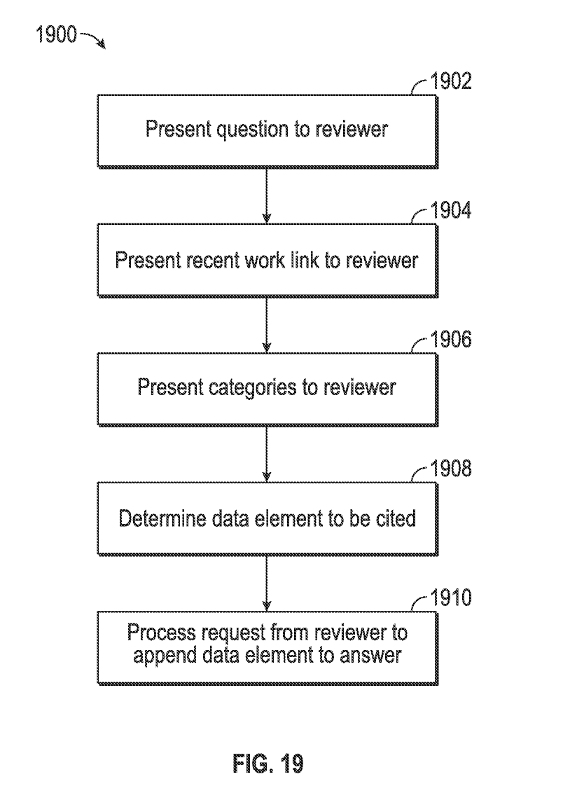

FIG. 19 is a flow chart of an exemplary method 1900 for augmenting performance summary answers to include objective data elements retrieved from a linked database of tracked objects. In particular, the method 1900 includes displaying or otherwise presenting (Task 1902) a question to a reviewer in a user interface, and presenting (Task 1904) a link to a database of recent work. In response to the user selecting the recent work link, the system presents (Task 1906) categories of tracked objects to the user. The system determines (Task 1908) a data element to be appended to the question, for example, by presenting a citation icon to the user (and the user selecting it). The method further includes processing (Task 1910) a request from the user to add the selected data element to the answer, for example, by displaying an “add” or “confirm” icon to the user (and the user selecting it).

A method is thus provided for augmenting performance summary answers with objective data elements retrieved from a linked database of tracked objects. The method involves: displaying a question to a reviewer in a user interface; displaying a link to a database of recent work to the reviewer in the user interface; in response to the reviewer selecting the recent work link, displaying a plurality of categories of the tracked objects to the reviewer; determining a data element to be appended to an answer to the question; and processing a request from the reviewer to add the selected data element to the answer.

In an embodiment, the method also includes displaying a detail view of the selected category in response to the reviewer selecting one of the categories of tracked objects.

In an embodiment, the detail view comprises a time line view of chronologically sequential elements of the selected category.

In an embodiment, displaying a plurality of categories of the tracked objects to the reviewer comprises displaying a plurality of virtual buttons, each corresponding to a respective category of performance metrics.

In an embodiment, displaying a plurality of categories of the tracked objects to the reviewer comprises displaying a detail view of the plurality of categories.

In an embodiment, the detail view comprises a time line view of chronologically interleaved elements from the plurality of categories.

In an embodiment, displaying a plurality of categories of the tracked objects comprises defining a beginning date and an end date within which the plurality of categories are bounded.

In an embodiment, displaying the plurality of categories of tracked objects comprises presenting a citation icon to the reviewer, and receiving an indication that the reviewer has selected the citation icon.

In an embodiment, the plurality of categories comprises at least two of: current summaries; past summaries; goals; thanks; feedback; and coaching.

In an embodiment, the database of recent work comprises a remote electronic database of tracked data objects.

In an embodiment, the method also involves appending a written answer received from the reviewer to the displayed question, and processing a request from the reviewer comprises appending the selected data element to the answer.

Machine readable computer code stored in a non-transient medium is also provided for use in a computer system of the type including a display configured to present an interactive user interface to a reviewer, an input module configured to receive input from a reviewer, and a processor configured to execute the computer code to implement the steps of: displaying a question in the user interface; appending an answer to the question received from the reviewer; displaying a link to a database of recent work in the user interface; in response to selection of the recent work link, displaying a plurality of categories of tracked data objects in the user interface, each category comprising at least one data element; and appending a selected data element to the answer.

In an embodiment, the machine readable computer code is further configured to display a detail view of the selected category in response to the reviewer selecting one of the categories of tracked data objects, wherein the detail view comprises a time line view of chronologically sequential elements of the selected category.

In an embodiment, displaying a plurality of categories of the tracked data objects comprises one of: displaying a plurality of virtual buttons, each corresponding to a respective category of performance metrics; and displaying a detail view of the plurality of categories.

In an embodiment, the detail view comprises a time line view of chronologically interleaved elements from the plurality of categories.

In an embodiment, displaying a plurality of categories of tracked data objects comprises defining a beginning date and an end date within which the plurality of categories are bounded.

In an embodiment, the machine readable computer code is further configured to implement the steps of: presenting a citation icon to the reviewer; receiving an indication that the reviewer has selected the citation icon; and displaying the plurality of categories of tracked objects in response to receiving an indication that the reviewer has selected the citation icon.

In an embodiment, the plurality of categories comprises at least two of: current summaries; past summaries; goals; thanks; feedback; and coaching.

In an embodiment, the machine readable computer code is further configured to implement the steps of: appending the selected data elements to the answer in response to the reviewer selecting at least one data element from each of at least two categories.

A user interface is also provided for appending data objects to answers while conducting performance reviews. The user interface includes an interactive module for presenting a question and receiving an associated answer; a selection field including virtual buttons corresponding to a plurality of respective performance metrics; a timeline feed configured to present an immersive view of at least one of the plurality of respective performance metrics; and a citation icon for use in appending at least one data element to the answer-

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions.

For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another. That said, in exemplary embodiments, the subject matter described herein is implemented in conjunction with a virtual customer relationship management (CRM) application in a multi-tenant environment.

Other implementations may include a non-transitory computer readable storage medium storing instructions executable by a processor to perform a method as described above. Yet another implementation may include a system including memory and one or more processors operable to execute instructions, stored in the memory, to perform a method as described above.

The examples illustrating the use of technology disclosed herein through social networking system should not be taken as limiting or preferred. This example sufficiently illustrates the technology disclosed without being overly complicated. It is not intended to illustrate all of the technologies disclosed. For instance, it does not illustrate the use of tagging mechanism in enterprise applications and other personalized applications and with a multi-tenant database with complex and sophisticated architecture.

A person having ordinary skill in the art may appreciate that there are many potential applications for one or more implementations of this disclosure and hence, the implementations disclosed herein are not intended to limit this disclosure in any fashion.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed:

1. A method of augmenting performance summary answers with objective data elements retrieved from a linked database of tracked objects, the method comprising:
providing a graphical user interface (GUI) for display on a computer monitor;
displaying a question to a reviewer in the user interface;
displaying a link to a database of recent work to the reviewer in the user interface;
in response to the reviewer selecting the recent work link using input/output hardware associated with the computer monitor, displaying a plurality of categories of the tracked objects to the reviewer;
determining a data element to be appended to an answer to the question; and
processing a request from the reviewer to add the selected data element to the answer.

2. The method of claim 1, further comprising:
in response to the reviewer selecting one of the categories of tracked objects, displaying a detail view of the selected category.

3. The method of claim 2, wherein the detail view comprises a time line view of chronologically sequential elements of the selected category.

4. The method of claim 1, wherein displaying a plurality of categories of the tracked objects to the reviewer comprises displaying a plurality of virtual buttons, each corresponding to a respective category of performance metrics.

5. The method of claim 1, wherein displaying a plurality of categories of the tracked objects to the reviewer comprises displaying a detail view of the plurality of categories.

6. The method of claim 5, wherein the detail view comprises a time line view of chronologically interleaved elements from the plurality of categories.

7. The method of claim 1, wherein displaying a plurality of categories of the tracked objects comprises defining a beginning date and an end date within which the plurality of categories are bounded.

8. The method of claim 1, wherein displaying the plurality of categories of tracked objects comprises presenting a citation icon to the reviewer, and receiving an indication that the reviewer has selected the citation icon.

9. The method of claim 1, wherein the plurality of categories comprises at least two of: current summaries; past summaries; goals; thanks; feedback; and coaching.

10. The method of claim 1, wherein the database of recent work comprises a remote electronic database of tracked data objects.

11. The method of claim 1, further comprising appending a written answer received from the reviewer to the displayed question, and wherein processing a request from the reviewer comprises appending the selected data element to the answer.

12. Machine readable computer code stored in a non-transient medium for use in a computer system of the type including a display configured to present an interactive user interface to a reviewer, an input module configured to receive input from a reviewer, and a processor configured to execute the computer code to implement the steps of:
displaying a question in the user interface;
appending an answer to the question received from the reviewer;
displaying a link to a database of recent work in the user interface;
in response to selection of the recent work link, displaying a plurality of categories of tracked data objects in the user interface, each category comprising at least one data element; and
appending a selected data element to the answer.

13. The machine readable computer code of claim 12, further configured to implement the step of:
in response to the reviewer selecting one of the categories of tracked data objects, displaying a detail view of the selected category;
wherein the detail view comprises a time line view of chronologically sequential elements of the selected category.

14. The machine readable computer code of claim 12, wherein displaying a plurality of categories of the tracked data objects comprises one of:
displaying a plurality of virtual buttons, each corresponding to a respective category of performance metrics; and
displaying a detail view of the plurality of categories.

15. The machine readable computer code of claim 14, wherein the detail view comprises a time line view of chronologically interleaved elements from the plurality of categories.

16. The machine readable computer code of claim 12, wherein displaying a plurality of categories of tracked data objects comprises defining a beginning date and an end date within which the plurality of categories are bounded.

17. The machine readable computer code of claim 12, further configured to implement the steps of:
presenting a citation icon to the reviewer;
receiving an indication that the reviewer has selected the citation icon; and
displaying the plurality of categories of tracked objects in response to receiving an indication that the reviewer has selected the citation icon.

18. The machine readable computer code of claim 12, wherein the plurality of categories comprises at least two of: current summaries; past summaries; goals; thanks; feedback; and coaching.

19. The machine readable computer code of claim 18, further configured to implement the step of:
in response to the reviewer selecting at least one data element from each of at least two categories, appending the selected data elements to the answer.

20. A user interface for appending data objects to answers while conducting performance reviews, comprising:
an interactive module for presenting a question and receiving an associated answer;
a selection field including virtual buttons corresponding to a plurality of respective performance metrics;
a timeline feed configured to present an immersive view of at least one of the plurality of respective performance metrics; and
a citation icon for use in appending at least one data element to the answer.
